(19) United States
(12) Patent Application Publication
(10) Pub. No.: US 2008/0149219 A1
(43) Pub. Date: Jun. 26, 2008

(54) Dispenser of Cleaning Substance

(76) Inventors: Meir Gitelis, Moshav Bnei Atarot (IL); Rafi Amiras, Kfar Saba (IL)

Correspondence Address: HAIM FACTOR;Ofek Group Inc., 16192 Coastal Highway, Lewes, DE, 19958, US

(21) Appl. No.: 11/926,038

(22) Filed: Oct. 28, 2007

Related U.S. Application Data
(60) Provisional application No. 60/871,137, filed on Dec. 21, 2006.

(51) Int. Cl. A47J 47/18; F04B 33/00; B65B 1/04

(52) U.S. Cl. 141/312; 15/264; 220/501; 222/192

(57) ABSTRACT

In one aspect, the present invention is directed to a dispenser of cleaning substance, the dispenser comprises: a container for storing the cleaning substance apart of the content of a bucket; conveying mechanism for conveying the substance form the container into the bucket; and an attaching mechanism, for attaching the conveying mechanism and/or the cleaning substance container to the bucket. According to one embodiment of the invention, the cleaning substance container is embedded within the bucket. According to another embodiment of the invention, the cleaning substance container is a separate entity from the bucket. The conveying mechanism may be adapted to convey liquid, solid objects (such as tablets), gas, and so on. Accordingly the cleaning substance may be in the form of liquid, solid objects (such as tablets), gas, and so on.

The current application claims the benefit of U.S. Provisional Application No. 60/871,137, filed on Dec. 21, 2006, whose disclosure is incorporated herein by reference.

1. Field of the Invention

The present invention relates to the field of domestic and office appliances. More particularly, the present invention relates to a dispenser of cleaning substance.

2. Background of the Invention

A bucket, also called a pail or can, is a container with an open top and a flat bottom, usually attached to a semicircular carrying handle called bail. Buckets have been used since very ancient times, mainly for transporting water from a fountain or well into permanent reservoirs such as water holes and barrels. Nowadays buckets are mainly used to carry liquids such as paint, and other multi-piece objects such as sand and food, but also as a domestic appliance for carrying water and other liquids while cleaning a house, office, and the like.

In order to provide to the water stored in a bucket some characteristics, the user adds some substances, usually in the form of fluid.

Usually people use an external container of cleaning fluid, which is stored someplace in the house and at times the cleaning fluid has to be searched for and fetched. But, due to the inconvenience of measuring a desired quantity of the supplemental substance (such as a detergent), a user does not measure the desired quantity, which results with less or over effectiveness of the mixture of the water and supplemental substance.

It is an object of the present invention to provide a facility which allows a user to pour a desired quantity of added substance to the water/fluid within a bucket in a more convenient way than in the prior art.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

In one aspect, the present invention is directed to a dispenser of cleaning substance, the dispenser comprising:

a container for storing the cleaning substance apart of the content of a bucket;

conveying mechanism for conveying the substance form the container into the bucket; and

an attaching mechanism, for attaching the conveying mechanism and/or the cleaning substance container to the bucket.

According to one embodiment of the invention, the cleaning substance container is embedded within the bucket.

According to another embodiment of the invention, the cleaning substance container is a separated entity from the bucket.

According to one embodiment of the invention, the conveying mechanism is embedded within the bucket.

According to another embodiment of the invention, the conveying mechanism is a separate entity from the bucket.

According to some embodiments of the present invention, the conveying mechanism comprises a pump.

The conveying mechanism may be adapted to convey liquid, solid objects (such as tablets), gas, and so on. Accordingly the cleaning substance may be in the form of liquid, solid objects (such as tablets), gas, and so on.

In another aspect, the present invention is directed to a bucket, comprising:

a container for storing cleaning substance apart of the content of the bucket;

a conveying mechanism for conveying the substance form the container into the bucket; and

an attaching mechanism, for attaching the conveying mechanism and/or the cleaning substance container to the bucket.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 is a perspective view which schematically illustrates a bucket in which is installed a SCS dispenser, according to one embodiment of the invention.

FIG. 2 is a perspective view from a different angle than FIG. 1, which schematically illustrates a bucket, according to one embodiment of the invention.

FIG. 3 is a sectional view which schematically illustrates the structure of a bucket, according to one embodiment of the invention.

FIG. 4 schematically illustrates a plurality of buckets interlaced each other, according to one embodiment of the invention.

FIGS. 5 and 6 schematically illustrate an SCS dispenser, according to another embodiment of the invention.

FIG. 6 schematically illustrates a bucket 2 in which an SCS dispenser 22 has been installed.

FIGS. 7 and 8 schematically illustrate another embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of clarity.

The term Supplemental Cleaning Substance, or SCS, refers herein to a substance added to the content of a bucket (which usually comprises water or a mixture of water), in order to provide to the water/mixture additional characteristics, such as ability to disinfect a cleaned surface, ability to shine a cleaned surface, and so on. A detergent is an example of SCS. An SCS may be in the form of fluid, solids (e.g. tablets), gas, and so on.

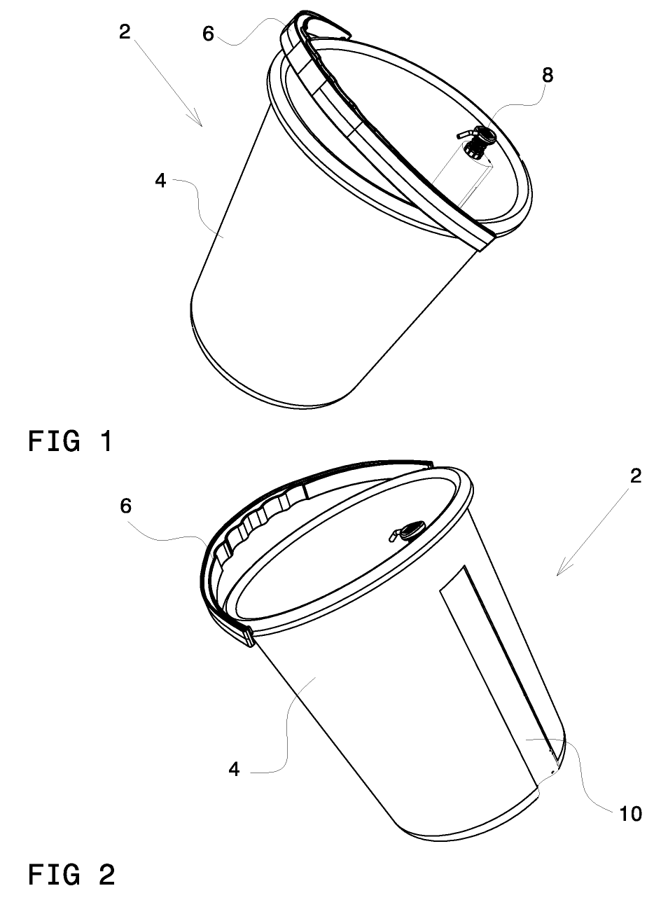

FIG. 1 is a perspective view which schematically illustrates a bucket in which is installed a SCS dispenser, according to one embodiment of the invention.

FIG. 2 is a perspective view from a different angle than FIG. 1, which schematically illustrates a bucket, according to one embodiment of the invention.

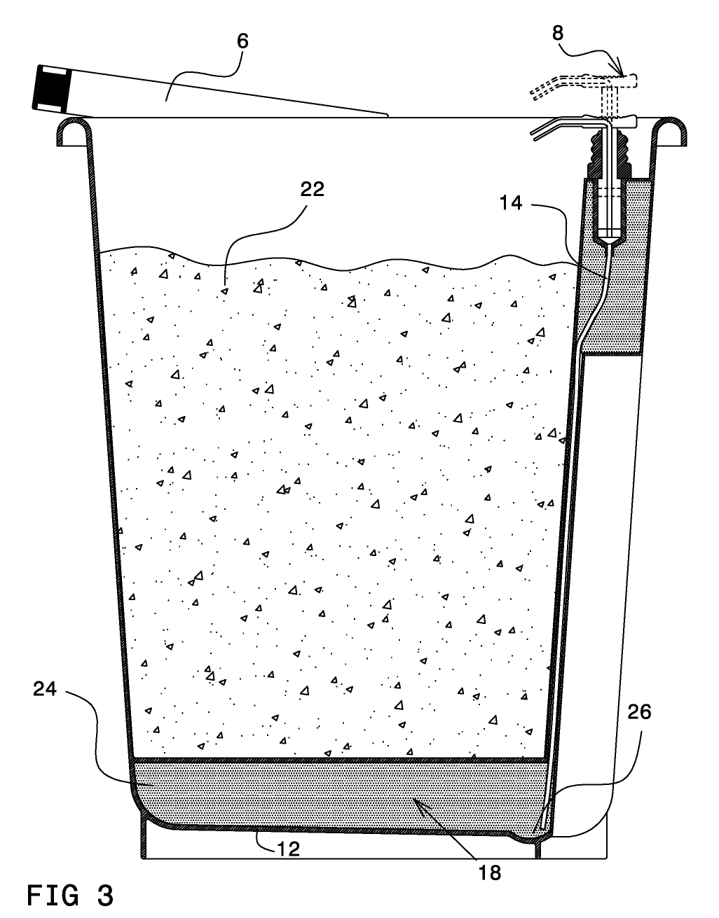

FIG. 3 is a sectional view which schematically illustrates the structure of a bucket, according to one embodiment of the invention.

The common structure of a bucket of the prior art comprises a container 4, and a carrying handle 6.

The point which characterizes bucket 2 illustrated in these figures from buckets of the prior art is an SCS dispenser which is embedded within the bucket.

According to these examples, the SCS is stored in a separate container 20, deployed underneath the container 4 of the bucket. A pump 8 pumps the SCS from container 20, and pours it into container 4, which comprises water or a mixture of water and other cleaning-related substance(s).

Since nowadays fluid pumps are well known in the art, for the sake of brevity a detailed description of the operation of the fluid pump is omitted.

It should be noted that in FIG. 3 the bottom 12 of container 18 has a small slope, thereby enabling the fluid therein to concentrate in depression 26, where tube 14 reaches. This way the majority of the SCS within container 18 may be pumped out from container 18.

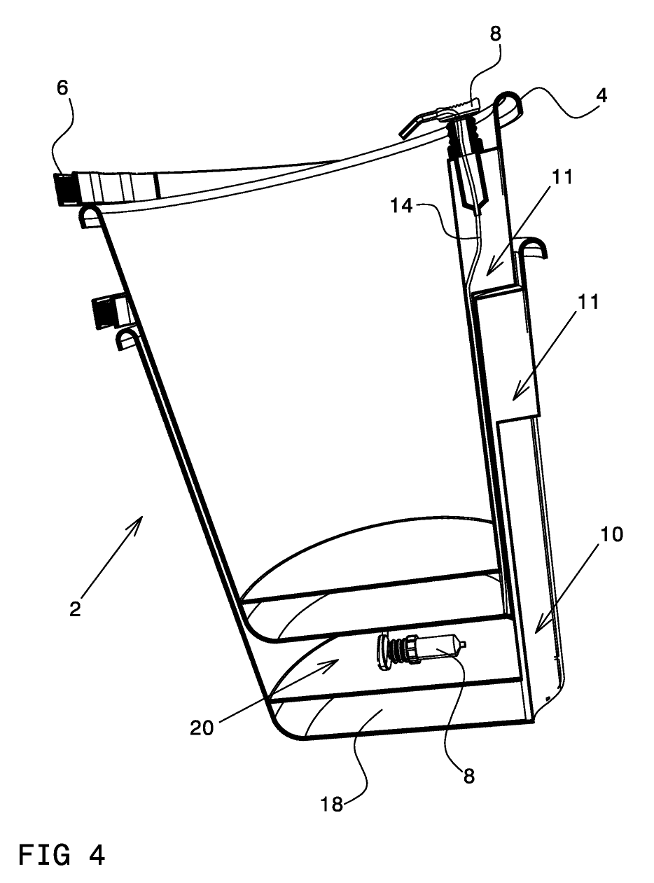

FIG. 4 schematically illustrates a plurality of buckets interlaced each other, according to one embodiment of the invention.

In the embodiment illustrated in FIG. 4, which comprises a depression 10 and a salient 11, enables interlacing a plurality of buckets 2 such that a space 20 remains between each two adjacent buckets. Space 20 may be used for storing some parts of the bucket, such as a part of the pump 8. Thus, according to this embodiment of the invention, a plurality of buckets 2 may be stored in a compact way.

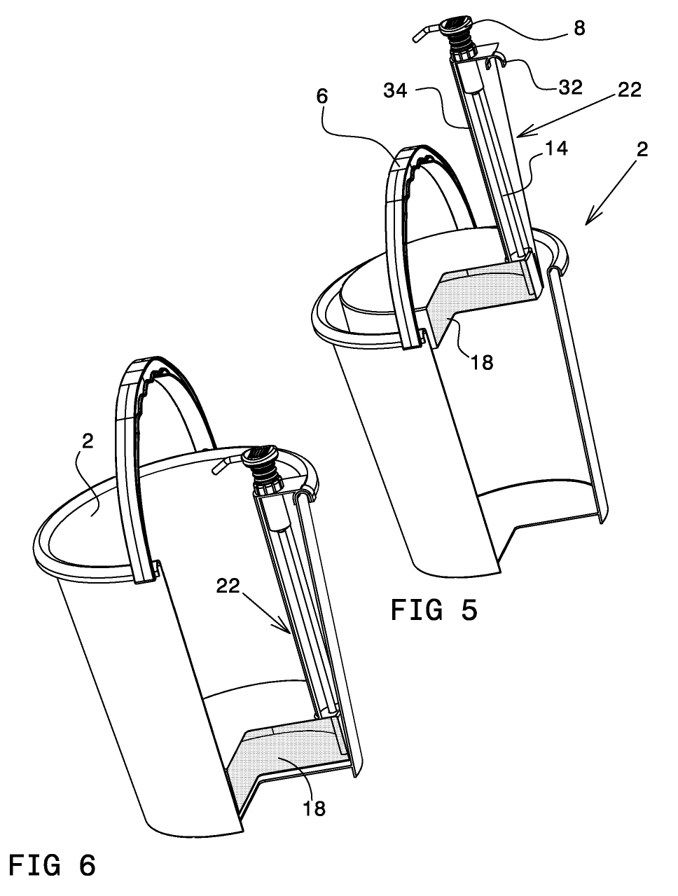

FIGS. 5 and 6 schematically illustrate an SCS dispenser, according to another embodiment of the invention.

The purpose of this embodiment is to allow using an SCS dispenser with a bucket which was not designed in advance to use the present invention.

According to this embodiment of the invention, dispenser 22 comprises container 18 and a pump assembly 34 thereof. The dispenser is a separate entity from the bucket 2. Dispenser 22 may be placed installed inside a bucket 2, and secured to the edge of bucket 2 by a clip 32.

FIG. 6 schematically illustrates a bucket 2 in which an SCS dispenser 22 has been installed.

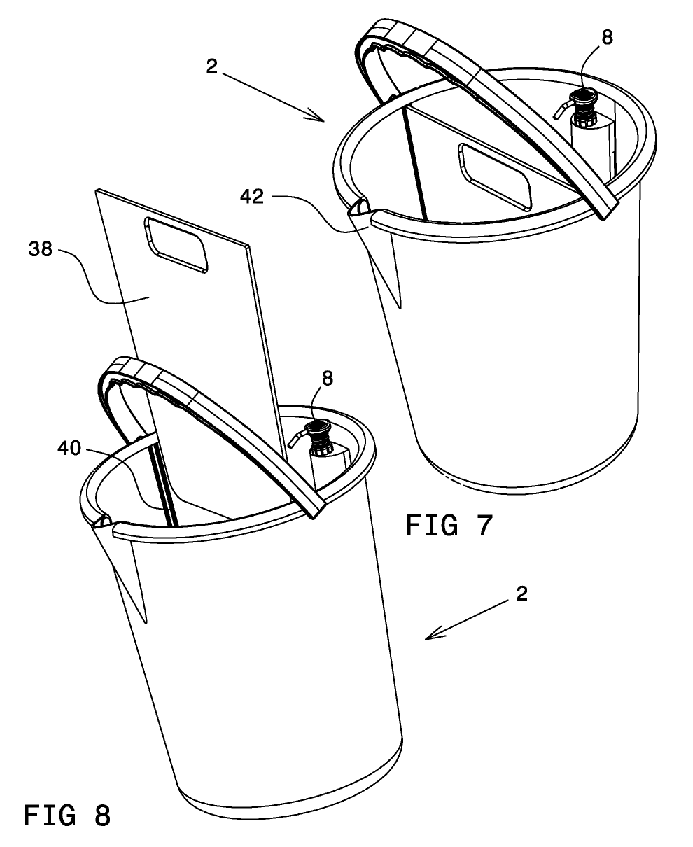

FIGS. 7 and 8 schematically illustrate another embodiment of the invention.

According to this invention, the interior side of the container of a bucket 2 is divided into two parts by a septum 38. Septum 38 may be removable, as illustrated in FIG. 8.

In the figures and the description herein, the following numerals have been mentioned:
Numeral 2 denotes a bucket;
numeral 4 denotes a container of fluid;
numeral 6 denotes a carrying handle;
numeral 8 denotes a handle for activating a pump;
numeral 10 denotes a depression in the external edge of bucket 2;
numeral 11 denotes a salient in the external edge of bucket 2, which corresponds to depression 10;
numeral 12 denotes the bottom of SCS container 18;
numeral 14 denotes a tube through which SCS 24 is pump from SCS container 18;
numeral 18 denotes an SCS container;
numeral 20 denotes a space between two interlaced buckets;
numeral 22 denotes an SCS dispenser;
numeral 26 denotes a depression in container 18, which is the lower part of the container 18;
numeral 32 denotes a clip for securing assembly 22 to the edge of a bucket 2;
numeral 34 denotes a pump assembly;
numeral 38 denotes a septum;
numeral 40 denotes rails for septum 38;
numeral 42 denotes a funnel, through which liquid is poured out of bucket 2.

In these examples and figures herein, the SCS is fluid, but it should be noted that the SCS may be in the form of solid or other form, and therefore the SCS dispenser should be adapted to dispense substance in the form of the SCS. As known to those skilled in the art, fluid, solid and gas dispensers are well known nowadays.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A dispenser of cleaning substance, the dispenser comprising:
a container for storing said cleaning substance apart of the content of a bucket;
a conveying mechanism for conveying said substance form said container into said bucket; and
an attaching mechanism, for attaching said conveying mechanism and/or said cleaning substance container to said bucket.

2. A dispenser according to claim 1, wherein said cleaning substance container being embedded within said bucket.

3. A dispenser according to claim 1, wherein said cleaning substance container is separate entity from said bucket.

4. A dispenser according to claim 1, wherein said conveying mechanism being embedded with said bucket.

5. A dispenser according to claim 1, wherein said conveying mechanism is separate entity from said bucket.

6. A dispenser according to claim 1, wherein said conveying mechanism comprises a pump.

7. A dispenser according to claim 1, wherein said conveying mechanism is adapted to convey liquid.

8. A dispenser according to claim 1, wherein said conveying mechanism is adapted to convey solid objects.

9. A dispenser according to claim 1, wherein said conveying mechanism is adapted to convey gas.

10. A dispenser according to claim 1, wherein said conveying mechanism is adapted to convey tablets.

11. A dispenser according to claim 1, wherein said cleaning substance comprises liquid.

12. A dispenser according to claim 1, wherein said cleaning substance comprises solid objects.

13. A dispenser according to claim 1, wherein said cleaning substance comprises gas.

14. A dispenser according to claim 1, wherein said cleaning substance comprises tablets.

15. A bucket, comprising:
a container for storing cleaning substance apart of the content of the bucket;
a conveying mechanism for conveying said substance form said container into said bucket; and
an attaching mechanism, for attaching said conveying mechanism and/or said cleaning substance container to said bucket.

16. A bucket according to claim 15, wherein said conveying mechanism comprises a pump.

17. A bucket according to claim 15, wherein said conveying mechanism is adapted to convey liquid.

18. A bucket according to claim 15, wherein said conveying mechanism is adapted to convey solid objects.

19. A bucket according to claim 15, wherein said conveying mechanism is adapted to convey gas.

20. A bucket according to claim 15, wherein said conveying mechanism is adapted to convey tablets.
